(19) United States
(12) Patent Application Publication
(10) Pub. No.: US 2009/0210149 A1
(43) Pub. Date: Aug. 20, 2009

(54) SYSTEM AND METHOD OF LONGITUDE AND LATITUDE COORDINATE TRANSFORMATION

(76) Inventor: Sheldon G. Willis, Upper Burrell, PA (US)

Correspondence Address: ECKERT SEAMANS CHERIN & MELLOTT, 600 GRANT STREET, 44TH FLOOR, PITTSBURGH, PA, 15219, US

(21) Appl. No.: 12/031,786

(22) Filed: Feb. 15, 2008

(51) Int. Cl. G01C 21/00

(52) U.S. Cl. 701/208

(57) ABSTRACT

A coordinate transformation system determines the position of a railroad vehicle. The system includes a global positioning system receiver outputting a longitude and a latitude of the vehicle. Each of the longitude and latitude is angular position bounded by a first predetermined longitude and a greater second predetermined longitude or a first predetermined latitude and a greater second predetermined latitude, respectively. A processor includes an input inputting the longitude and the latitude, a routine determining a first distance approximating a distance corresponding to the latitude as a function of the latitude, a third angular position and a first predetermined value, determine a second distance approximating a distance corresponding to the longitude as a function of the longitude, a fourth angular position and a second value, and an output outputting the first and second distances.

### BACKGROUND OF THE INVENTION

1. Field of the Invention

This invention pertains generally to location determining systems and, more particularly, to such systems for determining position of an object, such as a vehicle. The invention also pertains to methods of determining the location of an object.

2. Background Information

The haversine formula is an equation important in navigation. This provides great-circle distances between two points on a sphere from their longitudes and latitudes. The haversine formula is a special case of a more general formula in spherical trigonometry, the law of haversines, which relates the sides and angles of spherical “triangles”.

It is known to use the haversine formula of Equations 1-3, below, to approximate the distance (D) between two points on the Earth's surface along a great circle route. A great circle is the intersection of a sphere with a plane going through its center and is the largest circle that can be drawn on a given sphere (e.g., as is approximated by the Earth's surface). Each of the two points is defined in terms of a longitude/latitude pair as may be obtained from a conventional global positioning system (GPS).

haversin(θ)=sin²(θ/2) (Eq. 1)

h=haversin(d/R)=haversin(Δφ)+cos(φ₁)cos(φ₂)haversin(Δλ) (Eq. 2)

D=Rhaversin⁻¹(h)=2 Rarcsin(\sqrt{h})=2 Rsin⁻¹(\sqrt{h}) (Eq. 3)

wherein:
θ is an angle (in radians);
R is the radius of the Earth;
φ₁ is the latitude of the first point (in radians);
φ₂ is the latitude of the second point (in radians);
λ₁ is the longitude of the first point (in radians);
λ₂ is the longitude of the second point (in radians);
Δφ is the latitude separation (Δφ=φ₁−φ₂) (in radians) of the two points; and
Δλ is the longitude separation (Δλ=λ₁−λ₂) (in radians) of the two points.

When using Equations 2 and 3, care must be taken to ensure that Equation 2 (h) does not exceed 1 due to a floating point error, since the distance D is only real for h from 0 to 1. The haversine formula is sometimes written in terms of the arctangent function, but this suffers from similar numerical problems near h=1. The haversine formula is only an approximation when applied to the Earth, because the Earth is not a perfect sphere. The Earth's radius R varies from about 6356.78 km at the poles to about 6378.14 km at the equator. There are small corrections, typically on the order of about 0.1%, assuming that the geometric mean of R of about 6367.45 km is used everywhere, because of this slight ellipticity of the Earth.

U.S. Pat. No. 6,011,461 discloses a GPS system that receives data indicative of the present geographic location of a receiver, and therefore of a vehicle, in the form of latitude and longitude coordinates. A GPS distance calculation is made as the square root of the sum of the squares of the GPS position coordinates previously obtained and the GPS position coordinates most recently obtained. Calculation of distance in this manner is an approximation because latitude and longitude lines are curved.

U.S. Pat. No. 5,893,043 discloses a process and an arrangement for determining the position of a vehicle moving on a given track by using a map matching process. At least three types of position measuring data in the form of object site data, path length data and route course data are obtained. A computer unit carries out, for each type of measuring data, a data correlation with a stored desired data quantity for the determination of position results, which are evaluated in an “m-out-of-n” decision making process. In this process, a given number “m” of the “n” determined position results is taken into account.

Some on-board computer systems for railroads use fixed point processing. Hence, those systems cannot readily accommodate the relatively complex trigonometric equations, such as Equations 1-3, of the haversine formula.

Therefore, there is room for improvement in location determining systems.

There is also room for improvement in methods of determining the location of an object.

### SUMMARY OF THE INVENTION

These needs and others are met by embodiments of the invention, which determine a first distance approximating a distance corresponding to a latitude as a function of the latitude, an angular position and a first predetermined value, which determine a second distance approximating a distance corresponding to a longitude as a function of the longitude, another angular position and a second value, and which output the first and second distances.

In accordance with one aspect of the invention, a system determines position of a vehicle. The system comprises: a global positioning system receiver structured to output a longitude and a latitude of the vehicle, each of the longitude and the latitude being a corresponding angular position, the longitude being greater than or equal to a first predetermined longitude and being less than or equal to a second predetermined longitude, which is greater than the first predetermined longitude, the latitude being greater than or equal to a first predetermined latitude and being less than or equal to a second predetermined latitude, which is greater than the first predetermined latitude; and a processor comprising: an input structured to input the longitude and the latitude, a routine structured to determine a first distance approximating a distance corresponding to the latitude as a function of the latitude, a third angular position and a first predetermined value, determine a second distance approximating a distance corresponding to the longitude as a function of the longitude, a fourth angular position and a second value, and an output structured to output the first distance and the second distance.

The routine may be structured to subtract the third angular position from the latitude to provide a latitude difference, subtract the fourth angular position from the longitude to provide a longitude difference, multiply the latitude difference by the first predetermined value to provide the first distance, and multiply the longitude difference by the second value to provide the second distance.

The processor may be structured to provide fixed point processing in the routine without providing floating point processing in the routine.

As another aspect of the invention, a location determining system comprises: a processor structured to input a latitude and a longitude of an object, the latitude being a first angular position, the longitude being a second angular position, the latitude being greater than or equal to a first predetermined latitude and being less than or equal to a second predetermined latitude, which is greater than the first predetermined latitude, the longitude being greater than or equal to a first predetermined longitude and being less than or equal to a second predetermined longitude, which is greater than the first predetermined longitude, the processor comprising: a routine structured to determine a first distance approximating a distance corresponding to the latitude as a function of the latitude, a third angular position and a first predetermined value, and determine a second distance approximating a distance corresponding to the longitude as a function of the longitude, a fourth angular position and a second value, and an output structured to output the first distance and the second distance.

The routine may be further structured to subtract the third angular position from the latitude to provide a latitude difference, subtract the fourth angular position from the longitude to provide a longitude difference, multiply the latitude difference by the first predetermined value to provide the first distance, and multiply the longitude difference by the second value to provide the second distance.

The routine may be further structured to compensate the second value as a function of the latitude.

The routine may be further structured to calculate the second value as being a second predetermined value plus the product of the latitude difference times a third predetermined value.

As another aspect of the invention, a method of determining a location of an object comprises: inputting a latitude and a longitude of the object, the latitude being a first angular position, the longitude being a second angular position, the latitude being greater than or equal to a first predetermined latitude and being less than or equal to a second predetermined latitude, which is greater than the first predetermined latitude, the longitude being greater than or equal to a first predetermined longitude and being less than or equal to a second predetermined longitude, which is greater than the first predetermined longitude; determining a first distance approximating a distance corresponding to the latitude as a function of the latitude, a third angular position and a first predetermined value; determining a second distance approximating a distance corresponding to the longitude as a function of the longitude, a fourth angular position and a second value; and outputting the first and second distances.

### BRIEF DESCRIPTION OF THE DRAWINGS

A full understanding of the invention can be gained from the following description of the preferred embodiments when read in conjunction with the accompanying drawings in which:

FIG. 1 is a block diagram of positive train control (PTC) system including a processor and a routine in accordance with embodiments of the invention.

FIG. 2 is a block diagram of a routine for the processor of FIG. 1 in accordance with an embodiment of the invention.

FIG. 3 is a plot showing a range of longitudes and latitudes including an origin and a point of interest in association with the routine of FIG. 2.

FIG. 4 is a block diagram of a look up table which is usable with the processor of FIG. 1 in accordance with another embodiment of the invention.

FIG. 5 is a block diagram of a position tag location system which is usable with the routine of FIG. 2 in accordance with another embodiment of the invention.

FIG. 6 is a plot of two local maps for the track of a railroad vehicle in accordance with another embodiment of the invention.

FIG. 7 is a plot of a local map showing the conversion between longitude and latitude coordinates and local map section coordinates in accordance with another embodiment of the invention.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; an on-board computer; or any suitable processing device or apparatus.

As employed herein, the term “vital” means that the acceptable probability of a hazardous event resulting from an abnormal outcome associated with a corresponding activity or thing is less than about 10⁻⁹/hour. Alternatively, the Mean Time Between Hazardous Events is greater than 10⁹ hours. Static data used by vital routines (algorithms), including, for example, track map data, has been validated by a suitably rigorous process under the supervision of suitably responsible parties.

As employed herein, the terms “railroad” or “railroad service” mean freight trains or freight rail service, passenger trains or passenger rail service, transit rail service, and commuter railroad traffic, commuter trains or commuter rail service.

As employed herein, the term “railroad vehicle” means freight trains, passenger trains, transit trains and commuter trains, or a number of cars of such trains or of a railroad consist.

As employed herein, the terms “carborne” and “carborne equipment” refer to things or equipment on-board a railroad vehicle.

The invention is described in association with a global positioning system receiver, although the invention is applicable to other location systems that output position references.

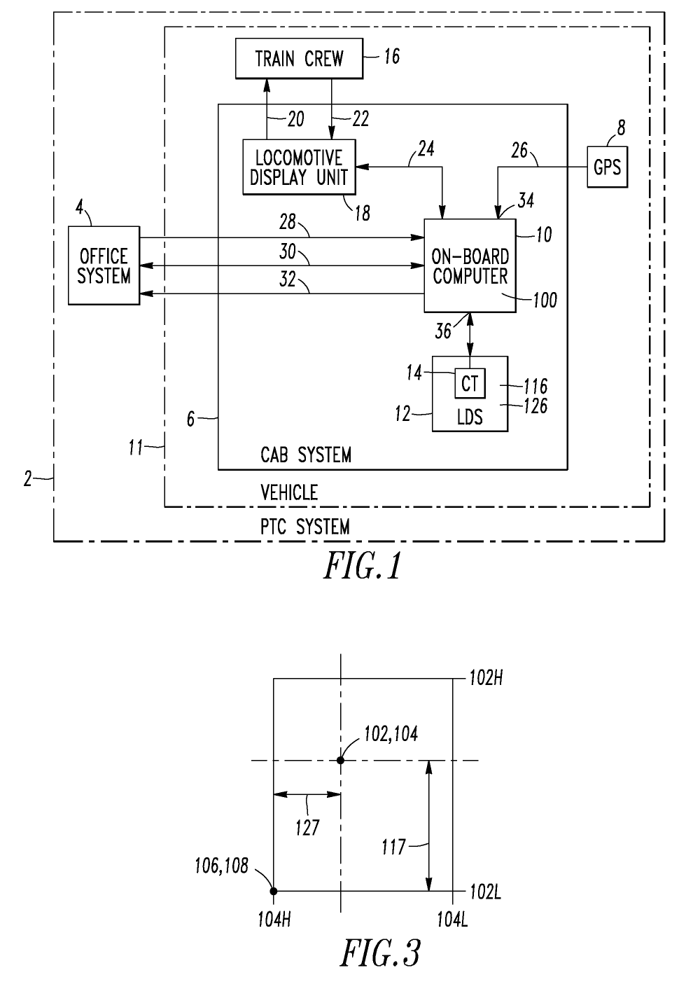

Referring to FIG. 1, a positive train control (PTC) system 2 includes an office system 4 and a carborne navigation system, such as the example CAB system 6 having a global positioning system (GPS) receiver 8. The GPS receiver 8 is, for example, a data radio mounted near a processor, such as the example on-board computer (OBC) 10. The GPS receiver 8 provides local geographic coordinates of an object, such as the example railroad vehicle (e.g., without limitation, train 11) (shown in phantom line drawing). The OBC 10 includes a location determining system (LDS) 12 having a coordinate transformation (CT) subsystem 14. A train crew 16 interfaces to the OBC 10 through a locomotive display unit (LDU) 18, which provides train status alerts 20 to and receives operator input 22 from the train crew 16. The LDU 18 also communicates data 24 to and from the OBC 10. The OBC 10 receives DGPS location inputs 26 from the GPS receiver 8. The GPS location can be expressed in a specific coordinate system (e.g., without limitation, latitude/longitude, using the WGS 84 geodetic datum or a suitable local system specific to a corresponding country). The office system 4 is, for example, a computer aided dispatch (CAD) system, which controls, at least, all of the railroad vehicles (one railroad vehicle 11 is shown in phantom line drawing) on a particular railroad line (not shown). The OCB 10 of the CAB system 6 has vital control of the railroad vehicle 11 and monitors the safe operation of the railroad vehicle 11 by the train crew 16. However, not all of the CAB system 6 needs to be vital. For example, the example locomotive display unit 18 is not vital. The OBC 10 can have both vital and non-vital functions. The OBC 10 receives track authorities and speed restrictions 28 from the office system 4, communicates alerts 30 to and from the office system 4, and outputs location reports 32 as well as confirmations of consist changes, power changes, switch positions and authorities to the office system 4.

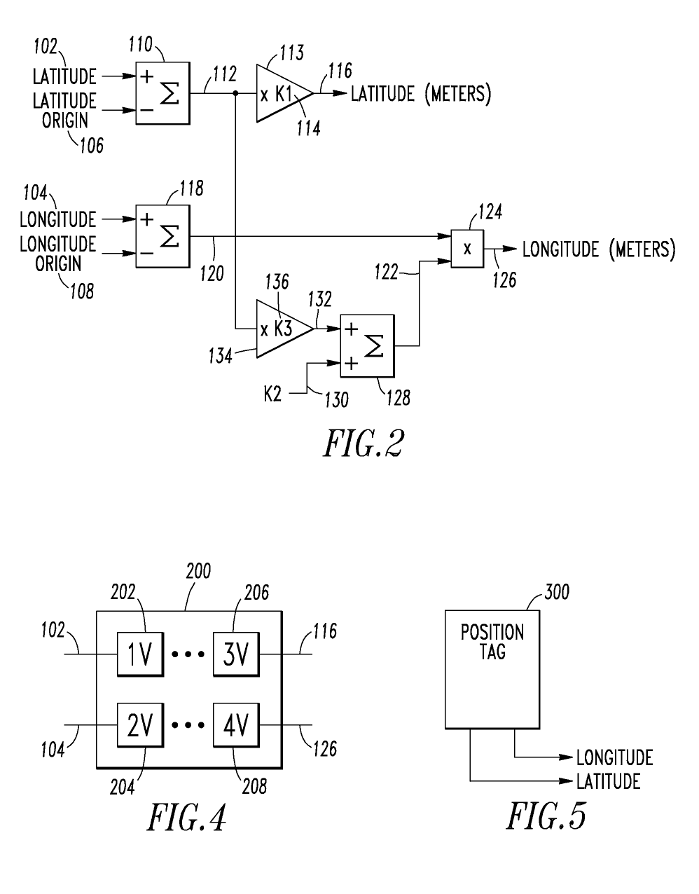

Also referring to FIG. 2, the LDS 12 determines the position 116,126 of the railroad vehicle 11 of FIG. 1. The example GPS receiver 8 outputs to the OBC 10 a longitude 104 and a latitude 102 of the railroad vehicle 11 as part of the DGPS location inputs 26. Each of the longitude 104 and the latitude 102 is a corresponding angular position (e.g., without limitation, measured in degrees), in which the longitude 104 is greater than or equal to a first predetermined longitude 104L and is less than or equal to a greater second predetermined longitude 104H, and in which the latitude 102 is greater than or equal to a first predetermined latitude 102L and is less than or equal to a greater second predetermined latitude 102H, as shown in FIG. 3. A non-limiting example of the longitude and latitude ranges is discussed, below, in connection with Example 1.

Although an example GPS receiver 8 is shown as the source of the DGPS location inputs 26, the longitude 104 and the latitude 102 may be obtained from a different source of those angular positions, as is discussed, below, in connection with Example 11.

As will be discussed in greater detail in connection with FIG. 2, the OBC 10 has an input 34 structured to input the longitude 104 and the latitude 102 of the DGPS location inputs 26, a routine 100 structured to determine a first distance 116 approximating a distance 117 (FIG. 3) corresponding to latitude as a function of the latitude 102, a third angular position, such as latitude origin 106, and a first predetermined value 114, and to determine a second distance 126 approximating a distance 127 (FIG. 3) corresponding to longitude as a function of the longitude 104, a fourth angular position, such as longitude origin 108, and a second value 122. Also, the OBC 10 includes an output 36 structured to output the first distance 116 and the second distance 126.

Continuing to refer to FIG. 2, a scaling and offset (scale distance conversion) routine 100 includes the Latitude input 102 and the Longitude input 104 from the DGPS location inputs 26 of FIG. 1, the Latitude origin input 106 and the Longitude origin input 108. The inputs 102,104,106,108 are preferably expressed in degrees. A subtraction function 110 subtracts the Latitude origin input 106 from the Latitude input 102 to provide a Latitude difference 112. A multiplication function 113 scales the Latitude difference 112 by a first fixed gain (K1) 114 to provide the Latitude output 116, which is preferably expressed in meters, although any suitable distance measure may be employed. A subtraction function 118 subtracts the Longitude origin input 108 from the Longitude input 104 to provide a Longitude difference 120. The Longitude difference 120 is scaled by a calculated gain (longitude scale) 122 using a multiplication function 124 to provide the Longitude output 126, which is preferably expressed in meters, although any suitable distance measure may be employed. The calculated gain 122 is determined by a summation function 128, which adds a second fixed gain (K2) 130 (which is a Longitude base scaling factor) and a variable gain 132, which is Latitude dependent. A multiplication function 134 multiplies the Latitude difference 112 by a third fixed gain (K3) 136 to provide the variable gain 132. Preferably, the OBC 10, and thus the routine 100, are structured to provide fixed point processing in the routine 100 without providing floating point processing therein.

As will be appreciated from FIG. 2, the routine 100 subtracts, at 110, the angular position of the latitude origin 106 from the latitude 102 to provide the latitude difference 112, subtracts, at 118, the angular position of the longitude origin 108 from the longitude 104 to provide the longitude difference 120, multiplies, at 113, the latitude difference 112 by the predetermined first fixed gain (K1) 114 to provide the first distance 116 (e.g., without limitation, in meters), and multiplies, at 124, the longitude difference 120 by the value 122 to provide the second distance 126 (e.g., without limitation, in meters). When the third predetermined fixed gain (K3) 136 is non-zero, steps 134 and 128 compensate the value 122 as a function of the latitude 102 and, in particular, the latitude difference 112. In particular, the value 122 is calculated as being the second predetermined fixed gain (K2) 130 plus the product, at 134, of the latitude difference 112 times the third predetermined fixed gain (K3) 136.

In FIG. 2, there is a Latitude/Longitude origin (106,108) that is subtracted from each respective Latitude/Longitude pair (102,104) of interest. Then, each result is multiplied by a scale factor (K1,K2), although the longitude path preferably includes the additional steps 134,128. Compensation to the longitude scaling is preferably employed as a function of latitude if the errors would, otherwise, be too large. Regardless, the latitude scaling is constant and ignores the relatively small Earth radius changes.

### EXAMPLE 1

For example, for a railroad, such as a railroad in Alaska, the latitude and longitude ranges are as follows: the latitude ranges from about 62.8° N to about 64.3° N, and the longitude ranges from about 148.8° W to about 149.7° W. For an example 0.000001° change in either longitude or latitude in the example latitude and longitude ranges when using the haversine formula (Equations 1-3), the longitude change in meters is from about 0.048 meters to about 0.051 meters, and the latitude change in meters is about 0.111 meters.

### EXAMPLE 2

As a non-limiting example for the disclosed routine 100, the latitude scaling factor K1 114 is about 0.111226 meters for each 0.000001° change in latitude, and the longitude scaling factor K2 130 is about 0.049542 meters for each 0.000001° change in longitude. Also, the origin (106,108) is defined, for example and without limitation, as the lowest latitude and the furthest west longitude, which for the example railroad is 62.8° N and 149.7° W. Alternatively, any suitable origin may be employed (e.g., the lowest latitude and the furthest east longitude; the highest latitude and the furthest west longitude; the highest latitude and the furthest east longitude; any point of a predetermined latitude range and a predetermined longitude range.

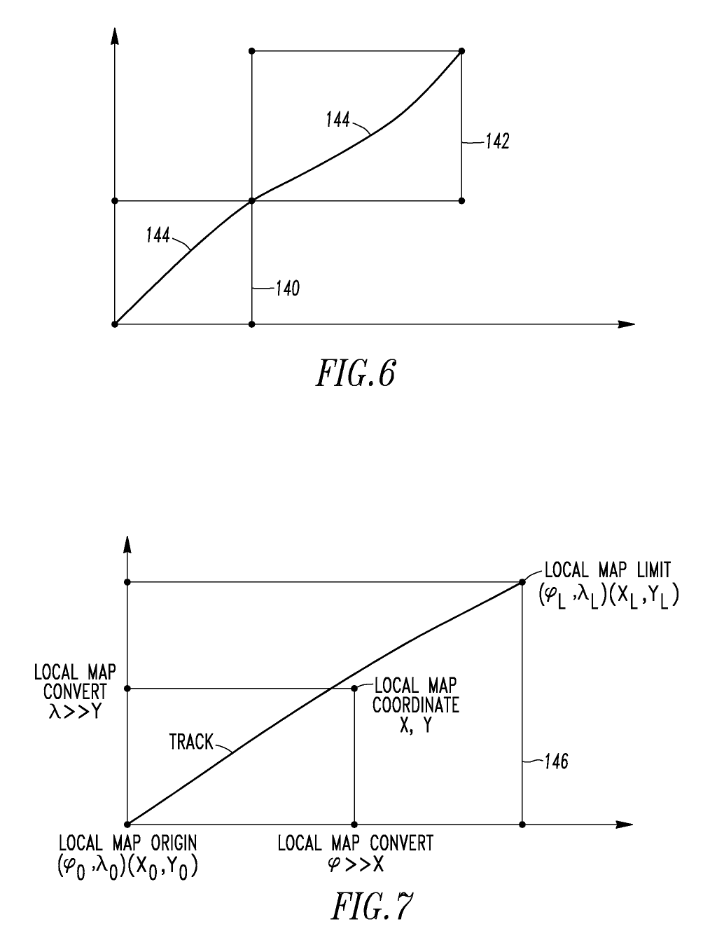

Preferably, a plurality of local maps of suitable size (e.g., without limitation, about one square mile in size) are employed, with the local map sections being configured in order that the change in latitude and the change in longitude are both always positive. An example of two local maps 140,142 for a railroad vehicle track 144 is shown in FIG. 6. The local map sections can have latitude and longitude boundaries based on a digital track map (not shown). The conversion can be done using the local map section boundaries.

### EXAMPLE 3

The example routine 100 of the example coordinate transformation (CT) subsystem 14 can be used, for example, in any railroad carborne mapping application including a navigation system. The disclosed subsystem 14 is particularly useful for vital systems that have limited computing capabilities.

### EXAMPLE 4

If, for example, the third predetermined fixed gain (K3) 136 is preset to zero, then a single longitude scale change is calculated for the entire latitude range. Here, no compensation to the longitude scaling is employed as a function of latitude. In this instance, the location determining system (LDS) 12 can tolerate the corresponding errors. Hence, the constant scale factor for longitude can be used if the error is suitably small. Here, the value 122 is equal to the predetermined fixed value (K2) 130.

### EXAMPLE 5

Referring to FIG. 3, as a non-limiting example, the first predetermined latitude 102L is about 62.8° N; the second predetermined latitude 102H is about 64.3° N; the first predetermined longitude 104L is about 148.8° W; and the second predetermined longitude 104H is about 149.7° W.

### EXAMPLE 6

As shown in FIG. 4, an alternative to the disclosed routine 100 of the subsystem 14 is the use of a look up table 200, which includes pre-calculations for the conversions of the routine 100. The example look up table 200 including a plurality of first values (1V) 202 corresponding to the latitude 102, a plurality of second values (2V) 204 corresponding to the longitude 104, a plurality of third values (3V) 206 corresponding to the first distance 116, and a plurality of fourth values (4V) 208 corresponding to the second distance 126 of FIG. 2. Here, the OBC 10 inputs the latitude 102 and the longitude 104 to the look up table 200, and outputs the first distance 116 and the second distance 126 from the look up table 200.

### EXAMPLE 7

The Latitude output 116 (meters) and the Longitude output 126 (meters) of the routine 100 are used by the location determining system (LDS) 12.

### EXAMPLE 8

In the routine 100 of FIG. 1, each of the four angular positions 102,104,106,108 is in units of degrees, and each of the distances 116,126 is in units of meters. As a non-limiting example, the example latitude 102 can range from about +62.8° to about +62.81515°, and the example longitude 104 can range from about −149.7° to about 149.690909°. The Latitude (meters) 116 and the Longitude (meters) 126 are determined from Equations 4 and 5, respectively.

Latitude (m)=(Latitude (degrees)−Latitude Origin (degrees))×Lat. Scaling (Eq. 4)

Longitude (m)=(Longitude (degrees)−Longitude Origin (degrees))×Long. Scaling (Eq. 5)

wherein:

Latitude Origin (degrees)=+62.8°;

Longitude Origin (degrees)=−149.7°;

Lat. Scaling=K1 114=0.111226 m/0.000001 degrees=111,226 m/degree; and

Long. Scaling=K2 130=0.049542 m/0.000001 degrees=49,542 m/degree.

### EXAMPLE 9

If, for example, local maps (e.g., without limitation, local maps 140,142 of FIG. 6) are employed, then the following coordinate transformation scaling procedure can be followed. First, the GPS latitude and GPS longitude coordinates are obtained in decimal degrees (φ, λ). Next, the corresponding local map section for the particular latitude/longitude coordinate pair (φ,λ) of interest is determined. This can be determined from the local map section origin coordinates (φ₀,λ₀) (e.g., decimal degrees) and the local map section limit coordinates (φ_{L},λ_{L}) (e.g., decimal degrees) of each of the local maps of interest, as is shown with the example local map 146 of FIG. 7. For the local map of interest, the local map section origin coordinates (φ₀,λ₀) (e.g., decimal degrees) are determined. Then, the local map section coordinate deltas (φ−φ₀),(λ−λ₀) are determined. Next, the local map section vertical (Y) coordinate (e.g., meters) is determined from Equation 6.

Y(meters)=LatScale*(φ−φ₀)+Y₀ (Eq. 6)

wherein:

Y is local map section vertical coordinate (e.g., meters);
LatScale is latitude scaling (e.g., K1 114 of FIG. 2);
(φ−φ₀) is local map section latitude coordinate delta change from the origin; and
Y₀ is local map section vertical origin (e.g., meters).

Then, the local map section longitude scaling is determined from Equation 7.

LongScale=LongScaleBase+LongScaleF(φ−φ₀) (Eq. 7)

wherein:
LongScaleF is longitude scaling factor (e.g., K3 136 of FIG. 2);
LongScaleBase is longitude scaling base (e.g., K2 130 of FIG. 2); and
LongScale is longitude scaling (e.g., 122 of FIG. 2).

Finally, the local map section horizontal (X) coordinate (e.g., meters) is determined from Equation 8.

X(meters)=LongScale*(φ−φ₀)+X₀ (Eq. 8)

wherein:
X₀ is local map section horizontal origin (e.g., meters).

Table 1, below, is an example based upon a number of sections of a map of suitable size. This includes a comparison of the conventional Haversine approach (third column) and the disclosed scaling procedure (fourth column) and corresponding scaling error (fifth column) of, for example, routine 100 of FIG. 1. The latitude (first column) and longitude (second column) change for each point in the table is 0.001515 and 0.000909 degrees, respectively. From the table, the worst case error is 0.0172 meters or approximately 100 parts per million. For example, the second row, third column shows the conventional Haversine distance (resulting from Equations 1-3, above) between the two points of the first and second rows. Similarly, the second row, fourth column shows the disclosed scaling procedure distance (resulting from Equations 4 and 5 (or Equations 6-8), above, and Equation 10, below) between the two points of the first and second rows. For instance, the distances in the third row are between the two points of the second and third rows, and the distances in the eleventh row are between the two points of the tenth and eleventh rows.

TABLE 1

| | | Haversine | Scaling | |
|---|---|---|---|---|
| | | change | change | Scaling error |
| Latitude | Longitude | (meters) | (meters) | (meters) |
| 62.80000 | −149.700000 | — | — | — |
| 62.80152 | −149.699091 | 174.747 | 174.747942 | 0.000942 |
| 62.80303 | −149.698182 | 174.747 | 174.749192 | 0.002192 |
| 62.80455 | −149.697273 | 174.746 | 174.750443 | 0.004443 |
| 62.80606 | −149.696364 | 174.746 | 174.751693 | 0.005693 |
| 62.80758 | −149.695455 | 174.745 | 174.752944 | 0.007944 |
| 62.80909 | −149.694545 | 174.744 | 174.754195 | 0.010195 |
| 62.81061 | −149.693636 | 174.744 | 174.755446 | 0.011446 |
| 62.81212 | −149.692727 | 174.743 | 174.756697 | 0.013697 |
| 62.81364 | −149.691818 | 174.742 | 174.757949 | 0.015949 |
| 62.81515 | −149.690909 | 174.742 | 174.759200 | 0.017200 |

### EXAMPLE 10

The total distanced traveled (d) from the origin is determined from Equations 9 and 10.

d²=(Latitude (m))²+(Longitude (m))² (Eq. 9)

d={square root over (((Latitude (m))²+(Longitude (m))²))} (Eq. 10)

### EXAMPLE 11

The disclosed coordinate transformation (CT) subsystem 14 can also be used by other location systems where other position references are employed, such as are output by a position tag 300 of FIG. 5.

The example LDS 12 determines the positions 116,126 using fixed point processing with a simplified coordinate transformation. The LDS 12 employs a relatively simple routine 100 as opposed to relatively complex trigonometric calculations used in conventional navigation systems. The routine 100 provides, for example, a scale distance calculation by subtracting a Latitude/Longitude origin (106,108) from each respective Latitude/Longitude pair (102,104) of interest, before each result is multiplied by a scale factor (114,130), in order to get the distance traveled (e.g., without limitation, in meters; in feet).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A system for determining position of a vehicle, said system comprising:
a global positioning system receiver structured to output a longitude and a latitude of said vehicle, each of said longitude and said latitude being a corresponding angular position, said longitude being greater than or equal to a first predetermined longitude and being less than or equal to a second predetermined longitude, which is greater than said first predetermined longitude, said latitude being greater than or equal to a first predetermined latitude and being less than or equal to a second predetermined latitude, which is greater than said first predetermined latitude; and
a processor comprising:
an input structured to input said longitude and said latitude,
a routine structured to determine a first distance approximating a distance corresponding to said latitude as a function of said latitude, a third angular position and a first predetermined value, determine a second distance approximating a distance corresponding to said longitude as a function of said longitude, a fourth angular position and a second value, and
an output structured to output said first distance and said second distance.

2. The system of claim 1 wherein said routine is further structured to subtract the third angular position from said latitude to provide a latitude difference, subtract the fourth angular position from said longitude to provide a longitude difference, multiply said latitude difference by the first predetermined value to provide said first distance, and multiply said longitude difference by the second value to provide said second distance.

3. The system of claim 1 wherein said system is a vital system.

4. The system of claim 1 wherein said system is a positive train control system.

5. The system of claim 1 wherein said system is a location determining system.

6. The system of claim 1 wherein said system is a coordinate transformation subsystem.

7. The system of claim 1 wherein said system is a carborne navigation system.

8. The system of claim 1 wherein said processor is structured to provide fixed point processing in said routine without providing floating point processing in said routine.

9. A location determining system comprising:
a processor structured to input a latitude and a longitude of an object, said latitude being a first angular position, said longitude being a second angular position, said latitude being greater than or equal to a first predetermined latitude and being less than or equal to a second predetermined latitude, which is greater than said first predetermined latitude, said longitude being greater than or equal to a first predetermined longitude and being less than or equal to a second predetermined longitude, which is greater than said first predetermined longitude, said processor comprising:
a routine structured to determine a first distance approximating a distance corresponding to said latitude as a function of said latitude, a third angular position and a first predetermined value, and determine a second distance approximating a distance corresponding to said longitude as a function of said longitude, a fourth angular position and a second value, and
an output structured to output said first distance and said second distance.

10. The location determining system of claim 9 wherein said routine is further structured to subtract the third angular position from said latitude to provide a latitude difference, subtract the fourth angular position from said longitude to provide a longitude difference, multiply said latitude difference by the first predetermined value to provide the first distance, and multiply said longitude difference by the second value to provide the second distance.

11. The location determining system of claim 10 wherein said routine is further structured to calculate said second value as being a second predetermined value plus the product of said latitude difference times a third predetermined value.

12. The location determining system of claim 9 wherein said routine is further structured to compensate said second value as a function of said latitude.

13. The location determining system of claim 9 wherein said second value is a second predetermined value.

14. The location determining system of claim 9 wherein said third angular position is said first predetermined latitude; and wherein said fourth angular position is said second predetermined longitude.

15. The location determining system of claim 14 wherein said first predetermined latitude is about 62.8° N; wherein said second predetermined latitude is about 64.3° N; wherein said first predetermined longitude is about 148.8° W; and wherein said second predetermined longitude is about 149.7° W.

16. The location determining system of claim 9 wherein each of said first, second, third and fourth angular positions is in units of degrees.

17. The location determining system of claim 9 wherein each of said first and second distances is in units of meters.

18. The location determining system of claim 9 wherein each of said first, second, third and fourth angular positions is in units of degrees; wherein each of said first and second distances is in units of meters; wherein said first predetermined value is about 0.111226 meters divided by 0.000001 degrees; and wherein said second value is about 0.049542 meters divided by 0.000001 degrees.

19. The location determining system of claim 9 wherein said longitude and said latitude are output by a position tag.

20. The location determining system of claim 9 wherein said longitude and said latitude are output by a global positioning system receiver.

21. A method of determining a location of an object, said method comprising:
inputting a latitude and a longitude of said object, said latitude being a first angular position, said longitude being a second angular position, said latitude being greater than or equal to a first predetermined latitude and being less than or equal to a second predetermined latitude, which is greater than said first predetermined latitude, said longitude being greater than or equal to a first predetermined longitude and being less than or equal to a second predetermined longitude, which is greater than said first predetermined longitude;
determining a first distance approximating a distance corresponding to said latitude as a function of said latitude, a third angular position and a first predetermined value;
determining a second distance approximating a distance corresponding to said longitude as a function of said longitude, a fourth angular position and a second value; and
outputting said first and second distances.

22. The method of claim 21 further comprising
subtracting a third angular position from said latitude to provide a latitude difference;
subtracting a fourth angular position from said longitude to provide a longitude difference;
multiplying said latitude difference by said first predetermined value to provide said first distance; and
multiplying said longitude difference by said second value to provide said second distance.

23. The method of claim 21 further comprising providing a look up table including a plurality of first values corresponding to said latitude, a plurality of second values corresponding to said longitude, a plurality of third values corresponding to said first distance, and a plurality of fourth values corresponding to said second distance;
inputting said latitude and said longitude to said look up table; and
outputting said first distance and said second distance from said look up table.

24. The method of claim 21 further comprising
compensating said second value as a function of said latitude.

25. The method of claim 21 further comprising
calculating said second value as being a second predetermined value plus the product of said latitude difference times a third predetermined value.
